(19) United States
(12) Patent Application Publication
(10) Pub. No.: US 2010/0070963 A1
(43) Pub. Date: Mar. 18, 2010

(54) MOBILE COMMUNICATION TERMINAL AND METHOD OF UPDATING SOFTWARE THEREOF

(75) Inventors: Hyung Deug BAE, Daejeon (KR); Nam Hoon Park, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/407,395

(22) Filed: Mar. 19, 2009

(30) Foreign Application Priority Data
Sep. 16, 2008 (KR) 10-2008-0090774

(51) Int. Cl. G06F 9/44

(52) U.S. Cl. 717/171

(57) ABSTRACT

There is provided mobile communication terminals and a method of updating software of the same. A method of updating software of mobile communication terminals includes, when software providers provide one or more pieces of update software for updating software of mobile communication terminals, creating a broadcast message including information about each piece of the update software, broadcasting the broadcast message to each of the mobile communication terminals over a wireless communication network, and, when a request to update the software of the mobile communication terminals is received from each of the mobile communication terminals that have received the broadcast message, providing a piece of corresponding update software to each of the corresponding mobile communication terminals over the wireless communication network. Accordingly, mobile communication terminals can be prevented from accessing a network unnecessarily, and ineffective use of wireless resources can be reduced.

### CROSS-REFERENCE TO RELATED APPLICATION

This application claims the benefit of Korean Application No. 10-2008-0090774, filed on Sep. 16, 2008 in the Korean Intellectual Property Office, the disclosure of which is incorporated herein by reference.

### BACKGROUND OF THE INVENTION

1. Field of the Invention

The present invention relates to a mobile communication terminal and a method of updating software of the same, and more particularly, to a mobile communication terminal, which is capable of downloading update software only when the update software is necessary, and a method of updating software of the same.

2. Description of the Related Art

An operating system (OS), firmware, and application software are installed in mobile communication terminals, such as mobile phones and personal portable devices. Such an OS, firmware, and application software are supplied by manufacturers, business entities, and service providers of mobile communication terminals. Bugs may be generated in software installed in mobile communication terminals and hinder normal operations of the mobile communication terminals. Accordingly, update software without bugs must be downloaded and installed in the mobile communication terminals. However, in order to download the update software, users of the mobile communication terminals must visit the service centers of manufacturing companies or service providers or access the service centers through the Internet. This makes users inconvenient to update the software of the mobile communication terminals. Further, in the case of software upgrade, like a case in which bugs have occurred, users of mobile communication terminals must upgrade software through a complicated process.

In order for users to update mobile communication terminals without visiting service centers or accessing the service centers through the Internet, there have been proposed methods of updating software through an Over The Air Interface (OTA).

Among the methods, there is a method of broadcasting a large amount of update software packages to all of mobile communication terminals over a network and of the mobile communication terminals selecting and downloading only desired ones of the broadcasted update software packages. However, this method is disadvantageous in that it wastes wireless resources ineffectively because a large amount of update software packages are indiscriminately broadcasted to all mobile communication terminals. In particular, a technology for downloading several mega bytes of radio software on terminals is required in a Software Defined Radio (SDR) system, that is, one of the next-generation mobile communication technologies. If the SDR system is commercialized in the future, this method may accelerate the consumption of wireless resources.

As another example, there is a method of mobile communication terminals periodically accessing a network in order to check whether software has been updated and, if software has been updated, downloading and installing the corresponding software. However, this method is disadvantageous in that it imposes a heavy burden on the traffic of a network because mobile communication terminals must periodically access the network unnecessarily even though software has not been updated.

Accordingly, there is a need for a method of allowing mobile communication terminals to access a network only when software is updated in order to prevent a heavy burden on network traffic and efficiently use wireless resources without broadcasting update software packages to all mobile communication terminals.

### SUMMARY OF THE INVENTION

In order to solve the above-described problems, it is an object of the present invention to provide a mobile communication terminal, which is capable of accessing a network only when update software occurs and downloading the update software, thereby being capable of preventing mobile communication terminals from accessing the network unnecessarily and reducing inefficient use of wireless resources, and a method of updating software of the same.

In order to achieve the above object, there is provided a method of updating software of mobile communication terminals, including, when software providers provide one or more pieces of update software for updating software of mobile communication terminals, creating a broadcast message including information about each piece of the update software; broadcasting the broadcast message to each of the mobile communication terminals over a wireless communication network; and when a request to update the software of the mobile communication terminals is received from each of the mobile communication terminals that have received the broadcast message, providing a piece of corresponding update software to each of the corresponding mobile communication terminals over the wireless communication network.

The above object is achieved by a mobile communication terminal, including an information storage unit for storing information about a type, hardware, and pieces of installed software, of the mobile communication terminal; a wireless communication unit for performing wireless communication over a wireless communication network and receiving a broadcast message, including information about each of pieces of update software for updating the pieces of software installed in the mobile communication terminal; and a download controller for determining whether to download the pieces of update software by comparing the broadcast message with the information stored in the information storage unit.

In the mobile communication terminals and the method of updating the software of the same, when an event, informing software update, is generated, the occurrence of the event is broadcast to each of the mobile communication terminals. Only some of the mobile communication terminals, which require software update, access the download server, download update software, and install the update software. Accordingly, mobile communication terminals can be prevented from accessing a network unnecessarily, and network traffic can be reduced. Further, wireless resources can be used efficiently because software packages can be prevented from being broadcast indiscriminately over a network.

### BRIEF DESCRIPTION OF THE DRAWINGS

FIG. 1 is a schematic block diagram of a software update system, including mobile communication terminals, according to the present invention;

FIG. 2 is a block diagram showing the construction of a download server of FIG. 1;

FIG. 3 is a block diagram showing the construction of a broadcasting message generated by the download server of FIG. 1;

FIG. 4 is a block diagram showing the construction of the mobile communication terminal of FIG. 1; and

FIG. 5 is a message sequence chart illustrating a process of updating software using the software update system, including the mobile communication terminals, according to the present invention.

### DETAILED DESCRIPTION OF THE INVENTION

Merits and characteristics of the present invention and a method of achieving the same will become more apparent from the following embodiments taken in conjunction with the accompanying drawings. However, the present invention is not limited to the disclosed embodiments, but may be implemented in various forms. The embodiments are provided to complete the disclosure of the present invention and to allow those having ordinary skill in the art to understand the scope of the present invention. The present invention is defined by the scope of the claims. The same reference numbers will be used throughout the drawings to refer to the same or like parts.

Hereinafter, the present invention will be described in detail with reference to the accompanying drawings.

In the method of updating software of a mobile communication terminal, a supplier provides software update information to each of the mobile communication terminals, and only some of mobile communication terminals whose software needs to be updated access the supplier and download corresponding update software. Accordingly, software update can be performed rapidly and conveniently.

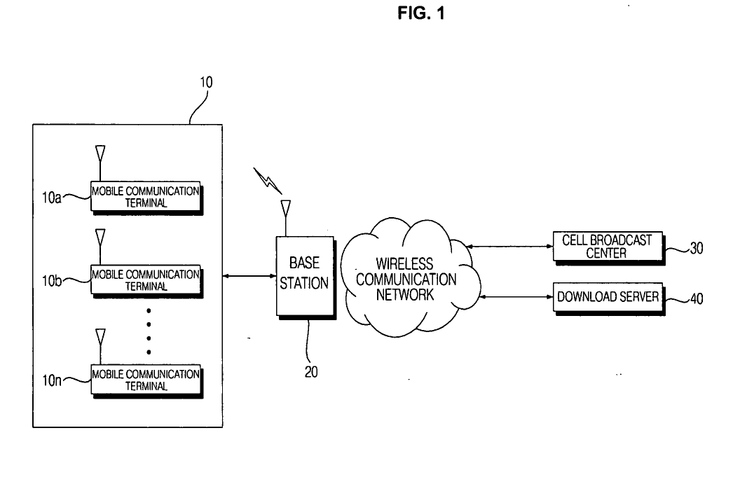

FIG. 1 is a schematic block diagram of a software update system, including mobile communication terminals, according to the present invention.

The software update system includes mobile communication terminals 10a, 10b, . . . , 10n (collectively referred to as ‘10’), a base station 20, a cell broadcast center 30, and a download server 40, and so on.

Each of the mobile communication terminals 10 communicates with the cell broadcast center 30 and the download server 40 over a wireless network, which uses a wireless communication protocol such as CDMA, WCDMA or GSM.

The base station 20 supports the mobile communication terminals 10 so that they can perform wireless communication over the wireless communication network using a wireless communication protocol.

The download server 40 provides each of the mobile communication terminals 10 with pieces of update software received from software suppliers. To this end, when the pieces of update software are provided by the software suppliers, the download server 40 provides update information about each of the pieces of the update software to each of the mobile communication terminals 10. When the respective mobile communication terminals 10 access the download server 40 in order to download the update software, the download server 40 provides proper update software to each of the mobile communication terminals 10.

The cell broadcast center 30 is deployed in a wireless communication network, such as CDMA, WCDMA or GSM, and is configured to broadcast a unilateral message to each of the mobile communication terminals 10 via the base station 20. The cell broadcast center 30 transmits unilateral messages, including pieces of update software, to one or more preset base stations 20, and a corresponding base station 20 transmits the messages to the respective mobile communication terminals 10, which belong to its wireless communication coverage. The cell broadcast center 30 broadcasts the information about each of the pieces of the update software to each of the mobile communication terminals 10 via the base station 20 at the request of the download server 40.

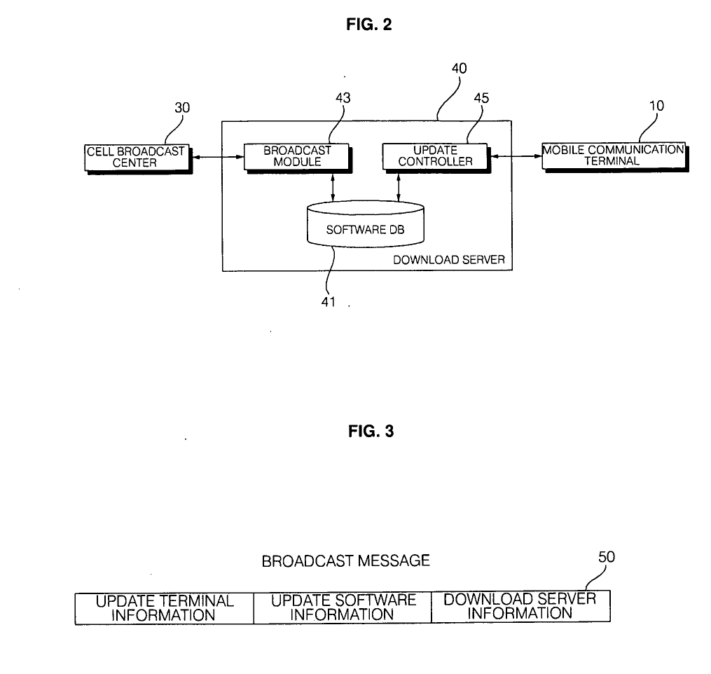

FIG. 2 is a block diagram showing the construction of the download server of FIG. 1.

The download server 40 includes a software database (DB) 41 for storing update software provided by software suppliers, a broadcast module 43 for broadcasting update information of update software to the cell broadcast center 30, and an update controller 45 for performing a control function of sending update software to the mobile communication terminals 10.

The software DB 41 stores update software provided by software suppliers and information about corresponding software. Here, the software suppliers may include manufacturers or business entities of the respective mobile communication terminals 10, manufacturers or service providers of programs installed in the respective mobile communication terminals 10, third parties and the like. The software suppliers may also include any manufacturers or business entities that provide software installed in the mobile communication terminals 10.

The information of the update software, stored in the software DB 41, is carried by a broadcast message created by the broadcast module 43, and contains respective identifiers of the update software, respective versions of the update software corresponding to the respective identifiers, and information about hardware types of the mobile communication terminals 10 in which the update software needs to be installed. The information of the update software may further contain suppliers of the update software, sizes of the update software, update dates, etc.

If update software is provided by software suppliers, the broadcast module 43 creates a broadcast message, containing information of the update software, and provides the created broadcast message to the cell broadcast center 30. The broadcast module 43 requests the cell broadcast center 30 to broadcast the broadcast message to the mobile communication terminals 10.

The broadcast message contains basic information, by which the mobile communication terminals 10 may determine whether to update their software, and it contains, as shown in FIG. 3, update terminal information, update software information, and download server information.

Here, the update terminal information contains information about hardware types of the mobile communication terminal 10 requiring update.

The update software information contains a list of update software required to be updated. The list of update software contains respective identifiers of update software and version information of the identifiers. The list of update software further contains pieces of update software, which are provided by software suppliers, such as an OS, firmware, and application software installed in the mobile communication terminals 10. Each piece of the update software has a unique software identifier. Here, the identifiers are unique software identifiers assigned to respective pieces of software installed in the mobile communication terminals 10. That is, different pieces of software identifiers are assigned to respective pieces of software installed in the same type of the mobile communication terminals 10. Accordingly, respective pieces of software installed in the same mobile communication terminals 10 can be distinguished from each other.

The download server information contains an IP address of the download server 40, which will be accessed in order to download update software therefrom.

If the mobile communication terminals 10 request download of update software, the update controller 45 sends the corresponding update software to the mobile communication terminals 10. At this time, the update controller 45 receives terminal types and a list of identifiers corresponding to respective pieces of update software from the mobile communication terminals 10 and checks update software that can be installed in the corresponding terminal types. Next, the update controller 45 searches the software DB 41 for the update software requested by the mobile communication terminals 10 and transmits the retrieved update software to the mobile communication terminals 10.

Alternatively, a process of authenticating the mobile communication terminals 10 trying to download update software may also be performed. In this case, an additional authentication module (not shown) may be needed. In the case in which the authentication module is used, the authentication module authenticates the mobile communication terminals 10, which is connected to the download server 40, using a variety of current authentication methods. For example, the download server 40 may permit only the mobile communication terminals 10 of subscribers who are members, to download update software. In this case, the authentication module receives information of the subscribers from the mobile communication terminals 10 and authenticates the mobile communication terminals 10 based on the received information. Alternatively, the download server 40 may provide update software to the mobile communication terminals 10 without an additional authentication process.

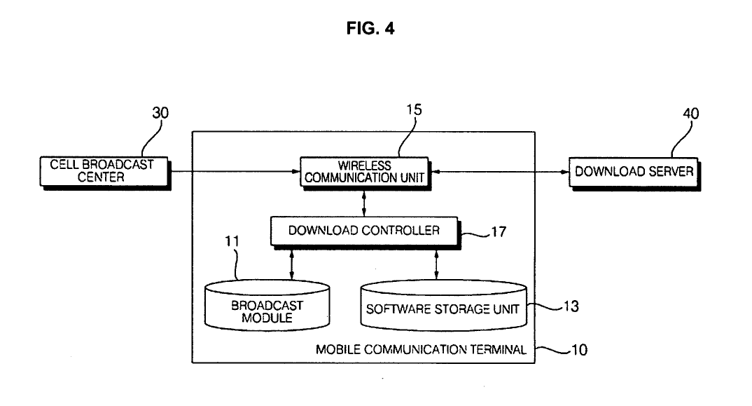

FIG. 4 is a block diagram showing the construction of the mobile communication terminal of FIG. 1.

The mobile communication terminals 10 receive a broadcast message 50 from the download server 40 via the cell broadcast center 30 and determine whether to download update software based on the broadcast message 50. If it is determined to download the update software, the mobile communication terminals 10 access the download server 40 and download corresponding update software. To this end, each of the mobile communication terminals 10 includes an information storage unit 11, a software storage unit 13, a wireless communication unit 15, and a download controller 17.

The information storage unit 11 stores terminal information and software information. The terminal information contains a type, hardware information, etc. of the mobile communication terminal 10. The software information contains a list and version information of software installed in the mobile communication terminal 10. Here, the list of software includes software identifiers. Identifiers of the same software distributed to the same type of the mobile communication terminals 10 must be identical to those of corresponding software stored in the software DB 41 of the download server 40. The software information is registered and maintained when the software is installed in or removed from the mobile communication terminals 10.

The software storage unit 13 stores an OS, firmware, and application software installed in the mobile communication terminal 10. Each piece of software stored in the software storage unit 13 is updated when each piece of update software is downloaded from the download server 40.

The wireless communication unit 15 performs wireless communication with the base station 20, and receives the broadcast message 50 from the cell broadcast center 30 via the base station 20 or transmits and receives data to and from the download server 40. The wireless communication unit 15 provides the broadcast message 50, which is received from the cell broadcast center 30, to the download controller 17 and transmits information, which is received from the download controller 17, to the download server 40. Further, the wireless communication unit 15 receives terminal information and a list of update software from the download controller 17 and transmits them to the download server 40. The wireless communication unit 15 provides an update software package, which is received from the download server 40, to the download controller 17.

The download controller 17 determines whether to update software of the mobile communication terminal 10 based on information received from the cell broadcast center 30, downloads adequate update software through data exchange with the download server 40, and installs the update software in the mobile communication terminal 10.

More specifically, when the broadcast message 50 is received from the cell broadcast center 30, the download controller 17 compares the update terminal information and the update software information, contained in the broadcast message 50, with the terminal information and the software information stored in the information storage unit 11. At this time, the download controller 17 determines whether the type of the corresponding mobile communication terminal 10 is identical to that of the terminal included in the broadcast message 50 by comparing the update terminal information of the broadcast message 50 with the terminal information of the information storage unit 11. If, as a result of the determination, the type of the corresponding mobile communication terminal 10 is different from that of the terminal included in the broadcast message 50, the download controller 17 ignores the broadcast message 50. However, if, as a result of the determination, the type of the corresponding mobile communication terminal 10 is identical to that of the terminal included in the broadcast message 50, the download controller 17 compares the update software information contained in the broadcast message 50 with the software information of the information storage unit 11. If, as a result of the comparison, versions of the software installed in the mobile communication terminal 10 are lower than those of the update software provided by the download server 40, the download controller 17 determines to download the update software. However, if, as a result of the comparison, the software versions of the information storage unit 11 are the same as or higher than the software version of the broadcast message 50, the download controller 17 ignores the broadcast message 50.

After it is determined to download the update software, the download controller 17 finds an IP address of the download server 40 based on download server information contained in the broadcast message 50. Next, the download controller 17 creates information of the type of the terminal and a list of software required to be updated and transmits them to the corresponding download server 40 through the wireless communication unit 15. Here, the list of software required to be updated includes identifiers of the software to be updated, information about versions of the software corresponding to the respective identifiers, and whether update of the software is essential or optional. When the update software is received from the download server 40, the download controller 17 stores the corresponding update software in the software storage unit 13 and installs the update software in the mobile communication terminal 10.

The download controller 17 may allow all pieces of software of the mobile communication terminal 10 or only software, indispensably requiring update to be updated according to user or by default. The download controller 17 may display the list of software to the outside in order for user to select corresponding software to be updated.

Meanwhile, in the case in which authentication is required in order to access the download server 40, the download controller 17 creates information for authentication and provides it to the download server 40.

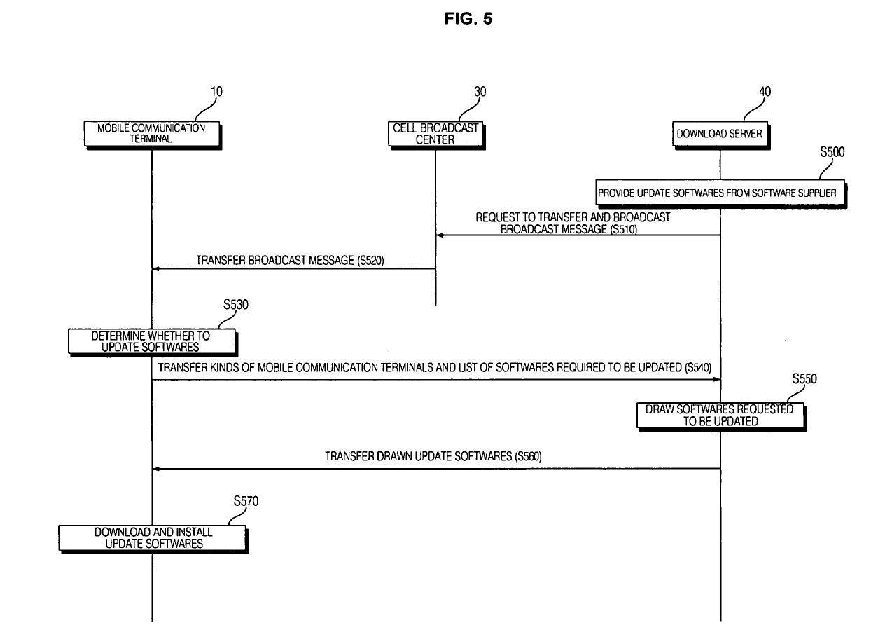

A process of updating software in the software update system constructed as above, including the mobile communication terminals 10, will be described below with reference to FIG. 5.

When pieces of update software are provided by software suppliers (S500), the broadcast module 43 of the download server 40 creates the broadcast message 50 including information of the update software. Next, the broadcast module 43 broadcasts the broadcast message 50 to the cell broadcast center 30, thus requesting the broadcast message 50 to be broadcast (S510). The cell broadcast center 30 transmits the broadcast message 50 to the mobile communication terminals 10 via the base station 20 (S520).

The wireless communication unit 15 of each of the mobile communication terminals 10 that have received the broadcast message 50 transmits the broadcast message 50 to the download controller 17. The download controller 17 determine whether a type of the corresponding mobile communication terminal 10 is identical to that of a terminal included in the broadcast message 50 by comparing update terminal information, contained in the broadcast message 50, with terminal information stored in the information storage unit 11. If, as a result of the determination, the type of the corresponding mobile communication terminal 10 is different from that of the terminal included in the broadcast message 50, the download controller 17 ignores the broadcast message 50 and terminates the process. However, if, as a result of the determination, the type of the corresponding mobile communication terminal 10 is identical to that of the terminal included in the broadcast message 50, the download controller 17 compares the update software information, contained in the broadcast message 50, with the software information stored in the information storage unit 11. If, as a result of the comparison, versions of the software installed in the mobile communication terminal 10 are lower than those of the update software provided by the download server 40, the download controller 17 determines to download the update software. However, if, as a result of the comparison, the software versions installed in the mobile communication terminal 10 are identical to or higher than those of the broadcast message 50, the download controller 17 ignores the broadcast message 50 and terminates the process (S530).

After it is determined to download the update software, the download controller 17 checks an IP address of the download server 40 based on download server information contained in the broadcast message 50. Next, the download controller 17 creates information about a type of the terminal and a list of software, requiring update, and transmits them to the wireless communication unit 15. The wireless communication unit 15 transmits the information about the type of the terminal and the list of software to the corresponding download server 40 (S540).

When the information about the type of the terminal and the list of software required to be updated are received from the mobile communication terminal 10 (S550), the download server 40 searches the software DB 41 for update software, which can be installed in the corresponding mobile communication terminal 10, of the list of update software and transmits the retrieved update software to the corresponding mobile communication terminal 10 (S560).

When the update software is received from the download server 40, the download controller 17 of the mobile communication terminal 10 stores the corresponding update software in the software storage unit 13 and installs the update software in the mobile communication terminal 10 (S570).

As described above, in the software update system including the mobile communication terminal 10, the download server 40 broadcasts the broadcast message 50, including information of update software, through the cell broadcast center 30, and only the mobile communication terminals 10 whose software needs to be updated, among the mobile communication terminals 10 that have received the broadcast message 50, access the download server 40 and download corresponding update software therefrom.

Although the embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of updating software of mobile communication terminals, comprising:
when software providers provide one or more pieces of update software for updating software of mobile communication terminals, creating a broadcast message including information about each piece of the update software;
broadcasting the broadcast message to each of the mobile communication terminals over a wireless communication network; and
when a request to update the software of the mobile communication terminals is received from each of the mobile communication terminals that have received the broadcast message, providing a piece of corresponding update software to each of the corresponding mobile communication terminals over the wireless communication network.

2. The method of claim 1, further comprising, if the broadcast message is received, determining whether each of the mobile communication terminals corresponds to a terminal type in which each piece of the update software can be installed.

3. The method of claim 2, further comprising, if, as a result of the determination, each of the mobile communication terminals corresponds to the terminal type in which each piece of the update software can be installed, comparing a version of the update software with a version of software installed in each of the mobile communication terminals.

4. The method of claim 3, further comprising, if, as a result of the determination, the version of the update software is lower than the version of the software installed in each of the mobile communication terminals, determining to download the update software.

5. The method of claim 4, further comprising:
allowing each of the mobile communication terminals to create a list of update software that are determined to download and request download of the update software,
wherein the list of update software comprises a type of each of the mobile communication terminals, an identifier for identifying each piece of the update software, and information about a version of each piece of the update software.

6. The method of claim 5, further comprising downloading the requested update software and installing the update software in each of the mobile communication terminals.

7. A mobile communication terminal, comprising:
an information storage unit for storing information about a type, hardware, and pieces of installed software, of the mobile communication terminal;
a wireless communication unit for performing wireless communication over a wireless communication network and receiving a broadcast message, including information about each of pieces of update software for updating the pieces of software installed in the mobile communication terminal; and
a download controller for determining whether to download the pieces of update software by comparing the broadcast message with the information stored in the information storage unit.

8. The mobile communication terminal of claim 7, wherein the download controller determines whether to download the pieces of update software by determining whether the mobile communication terminal corresponds to a type in which each of the pieces of update software can be installed and comparing a version of each of the pieces of update software, included in the broadcast message, and a version of each of the pieces of software installed in the mobile communication terminal.

9. The mobile communication terminal of claim 8, wherein the download controller determines to download the pieces of update software for only pieces of software, having versions lower than the versions of the pieces of update software, of the pieces of the software installed in the mobile communication terminals

10. The mobile communication terminal of claim 7, wherein, if it is determined to download each of the pieces of update software, the download controller requests to download each of the pieces of update software by providing a list of pieces and versions of software, requiring update, and the type information of the mobile communication terminal to a download server that provides each of the pieces of update software.
